(19) United States
(12) Patent Application Publication
(10) Pub. No.: US 2026/0222992 A1
(43) Pub. Date: Jul. 30, 2026

(54) Sleep state for links

(71) Applicant: NVIDIA CORPORATION, Santa Clara, CA (US)

(72) Inventors: Xutong Li, San Jose, CA (US); Mazhar Moshirvaziri, Los Gatos, CA (US); Harishankar Murugan, Pleasanton, CA (US); Alvin Ng, San Jose, CA (US); Edward Sears, Sudbury, MA (US); Pradyumna Desale, Campbell, CA (US); Sreedhar Narayanaswamy, Sunnyvale, CA (US)

(21) Appl. No.: 19/040,881

(22) Filed: Jan. 30, 2025

(51) Int. Cl. H04W 52/02

(52) U.S. Cl. CPC H04W 52/0235; H04W 52/0248

(57) ABSTRACT

In one embodiment, a distributed computing system includes multiple nodes to be interconnected by multiple physical links to convey traffic between the nodes, each node comprising link controller logic to control transitions of a physical link of the multiple physical links among states including an active state L0 in which the traffic is allowed to be conveyed by the physical link, a power saving state L1 in which traffic is not allowed to be conveyed by the physical link and having a first exit latency to the active state L0, and a sleep state in which traffic is not allowed to be conveyed by the physical link and providing higher power saving than the power saving state L1 and having a second exit latency to the active state L0, the second exit latency being greater than the first exit latency.

### FIELD OF THE DISCLOSURE

The present disclosure relates to computer systems, and in particular, but not exclusively to, reduced power for links.

### BACKGROUND

High speed interconnects, such as NVLink, have seen bandwidth and power growth generation over generation. NVIDIA® design hardware platforms that service different workloads, some of which (e.g., large language model (LLM) training workloads) may rely heavily on low latency and high bandwidth high speed interconnects between processors such as graphics processing units (GPUs) while others may not. Another issue that further complicates the power consumption aspect is the utilization pattern of workloads with short idle windows, e.g., where the majority of the idle windows are shorter than one millisecond in duration for some applications. Where the idle windows are shorter than one millisecond, for example, the interconnects do not enter a power saving state (e.g., L1), since the exit latency from the power saving state (e.g., in the range of 50 to 150 microseconds) will cause performance degradation. Therefore, the power saving state L1 is generally only transitioned to after a minimal time period of a link being idle to prevent the performance degradation described above.

### OVERVIEW

There is provided in accordance with still another embodiment of the present disclosure, a distributed computing system, including multiple nodes to be interconnected by multiple physical links to convey traffic between the nodes, each node including link controller logic to control transitions of a physical link of the multiple physical links among states including an active state L0 in which the traffic is allowed to be conveyed by the physical link, a power saving state L1 in which traffic is not allowed to be conveyed by the physical link and having a first exit latency to the active state L0, and a sleep state in which traffic is not allowed to be conveyed by the physical link and providing higher power saving than the power saving state L1 and having a second exit latency to the active state L0, the second exit latency being greater than the first exit latency.

Further in accordance with an embodiment of the present disclosure the link controller logic is to automatically change the state of the physical link from the active state L0 to the power saving state L1 in response to the physical link being idle of the traffic for a given time period.

Still further in accordance with an embodiment of the present disclosure the second exit latency of the sleep state is in the range of 1 to 10 seconds.

Additionally, in accordance with an embodiment of the present disclosure the first exit latency of the power saving state L1 is in the range of 10 to 150 microseconds.

Moreover, in accordance with an embodiment of the present disclosure the link controller logic is to perform periodic link recalibration to maintain electrical quality of the physical link while the physical link is in the power saving state L1, and not perform periodic link recalibration of the physical link while in the physical link is in the sleep state.

Further in accordance with an embodiment of the present disclosure, the system includes at least one resource manager is to receive user input indicative of how many of the multiple physical links to transition into the sleep state, wherein the physical links are grouped by interconnects between the multiple nodes, and control transition at least one of the multiple links of at least one of the interconnects into the sleep state based on the user input.

Still further in accordance with an embodiment of the present disclosure, the system includes at least one resource manager is to compute an indication of how many of the physical links are to transition into the sleep state based on system performance and/or power, and control transition at least one of the physical links into the sleep state based on the computed indication.

Additionally in accordance with an embodiment of the present disclosure the nodes include processing devices and switches.

Moreover, in accordance with an embodiment of the present disclosure the processing devices include any one or more of the following central processing units (CPUs), or graphics processing units (GPUs).

Further in accordance with an embodiment of the present disclosure the processing devices are connected indirectly via the switches using the physical links, wherein each of the processing devices is connected to each of the switches via at least one respective one of the physical links.

Still further in accordance with an embodiment of the present disclosure the switches are connected directly to each other via at least one of the physical links.

Additionally, in accordance with an embodiment of the present disclosure the nodes are connected directly to each other via at least one of the physical links.

There is also provided in accordance with still another embodiment of the present disclosure a resource manager system, including a processor to control transition among states of multiple physical links interconnecting multiple nodes, the multiple physical links being to convey traffic between the nodes, and an interface to receive data indicative of how many physical links to transition into a sleep state from a power saving state L1 and/or an active state L0, wherein the processor is to control transition of the states of corresponding ones of the physical links from the power saving state L1 and/or the active state L0 to the sleep state based on the received data, traffic is not allowed to be conveyed on the corresponding physical links in the power saving state L1, which has a first exit latency to the active state L0, and traffic is not allowed to be conveyed on the corresponding physical links in the sleep state, which provides a higher power saving than the power saving state L1 and has a second exit latency to the active state L0, the second exit latency being greater than the first exit latency.

Moreover, in accordance with an embodiment of the present disclosure the interface is to receive user input indicative of how many physical links to transition into the sleep state from the power saving state L1 and/or from the active state L0, and the processor is to control transition of the states of corresponding ones of the physical links from the power saving state L1 and/or active state L0 to the sleep state based on the received user input.

Further in accordance with an embodiment of the present disclosure the interface is to receive data indicative of system performance and/or power, the processor is to compute an indication of how many of the physical links are to transition into the sleep state based on system performance and/or power, and the processor is to control transition of the states of corresponding ones of the physical links from the power saving state L1 and/or active state L0 to the sleep state based on the computed indication.

There is also provided in accordance with another embodiment of the present disclosure, a distributed computing method, including conveying traffic over multiple physical links interconnecting multiple nodes, controlling transitions of a physical link of the multiple physical links among states including an active state L0 in which the traffic is allowed to be conveyed by the physical link, a power saving state L1 in which traffic is not allowed to be conveyed by the physical link and having a first exit latency to the active state L0, and a sleep state in which traffic is not allowed to be conveyed by the physical link and providing higher power saving than the power saving state L1 and having a second exit latency to the active state L0, the second exit latency being greater than the first exit latency.

Still further in accordance with an embodiment of the present disclosure, the method includes automatically changing the state of the physical link from the active state L0 to the power saving state L1 in response to the physical link being idle of the traffic for a given time period.

Additionally, in accordance with an embodiment of the present disclosure the second exit latency of the sleep state is in the range of 1 to 10 seconds.

Moreover, in accordance with an embodiment of the present disclosure the first exit latency of the power saving state L1 is in the range of 10 to 150 microseconds.

Further in accordance with an embodiment of the present disclosure, the method includes performing periodic link recalibration to maintain electrical quality of the physical link while the physical link is in the power saving state L1, and not performing periodic link recalibration of the physical link while the physical link is in the sleep state.

Still further in accordance with an embodiment of the present disclosure, the method includes receiving user input indicative of how many of the multiple physical links to transition into the sleep state, wherein the physical links are grouped by interconnects between the multiple nodes, and controlling transition at least one of the multiple links of at least one of the interconnects into the sleep state based on the user input.

Additionally in accordance with an embodiment of the present disclosure, the method includes computing an indication of how many of the physical links are to transition into the sleep state based on system performance and/or power, and controlling transition at least one of the physical links into the sleep state based on the computed indication.

### BRIEF DESCRIPTION OF THE DRAWINGS

The present disclosure will be understood from the following detailed description, taken in conjunction with the drawings in which:

FIGS. 1A-E are block diagram views of computer systems constructed and operative in accordance with an embodiment of the present disclosure;

FIG. 2 is a resource manager device for use in the computer systems of FIGS. 1A-E;

FIG. 3 is a block diagram view of example nodes constructed and operative in accordance with an embodiment of the present disclosure;

FIG. 4 is a flowchart including steps in a method of operation of the resource manager device of FIG. 2;

FIG. 5 is a flowchart including steps in an alternative method of operation of the resource manager device of FIG. 2;

FIG. 6 is a flowchart including steps in a method of operation of link controller logic for use in the computer systems of FIGS. 1A-E; and

FIG. 7 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

As previously mentioned, the links of high-speed interconnects consume a lot of power. For example, in some systems, processing devices such as central processing units (CPUs) and/or GPUs may be connected to each other using interconnects (e.g., NVLink) and optionally via one or more switches. The links of the interconnects are power hungry and therefore incorporate a power saving state L1 which may be used when traffic is not being conveyed over any one of the links.

For certain workloads, e.g., LLM workloads, the links are only actively conveying traffic for a small percentage, e.g., about 10-15%, of the time and therefore, for the majority of the time, these links are unused. Additionally, the traffic patterns include idle periods which are generally short enough that the links remain in active state L0 most of the time. This is because the length of the exit latency from the power saving state L1 to the active state L0 would result in performance degradation if an aggressive policy is set to enter power saving state L1 frequently. Although, in the active state L0 when no traffic is being conveyed during the idle periods uses less power than when traffic is actively being conveyed, the idle periods of the active state L0 still use more power than the power saving state L1. Therefore, for some workloads, when the idle periods are not long enough, power is wasted maintaining the links.

Embodiments of the present disclosure address at least some of the above drawbacks by providing a sleep state, which uses less power than the power saving state L1, and to which one or more of the links may be transitioned in order to save power. The links which are not transitioned to the sleep state may be allowed to automatically transition between the active state L0, and the power saving state L1, according to the traffic being conveyed by the non-sleep state links including the length of the idle states between actively conveying traffic. For example, if a link is idle for long enough while in active state L0, the link would transition to power saving state L1 automatically until the link becomes active again.

In the above manner, one or more given links which are in the sleep state provide a higher power saving than if they were in the power saving state L1, while the non-sleep state links are used for more traffic than they would otherwise be used if sleep state was not applied to the given link(s). If too many links are transitioned to the sleep state, the active links may become too busy and lead to performance degradation. Some workloads may be sensitive to latency as well and may experience performance degradation with link reduction irrespective of whether the link is busy. Therefore, the number of links which are transitioned to the sleep state should be selected carefully and dynamically adjusted to prevent performance degradation. The exit latency from the sleep state to the active state L0 is greater than the exit latency from power saving state L1 to the active state L0. In some embodiments, exit latency from the sleep state to the active state L0 is in the range of 1 to 10 seconds, while the exit latency from power saving state L1 to the active state L0 is in the range of 10 to 150 microseconds. In other embodiments, the ranges of the exit latency from the power saving state L1 and the sleep state to the active state L0 may be different, but generally the exit latency from the sleep state to the active state L0 is higher than the exit latency from power saving state L1 to the active state L0. It should be noted that the above example range may depend on various factors such as the link hardware and link management. Therefore, exit latency from the sleep state and the power saving state to active state may be less than the minimum in the example ranges stated above.

The lower exit latency for the power saving state L1 is at least partially due to periodic link recalibration (PEQ) that happens in the background in order to maintain link electrical quality at the cost of higher power because the link goes into active states while calibration is being performed. The sleep state does not perform PEQ in order to save power and therefore incurs an additional exit latency penalty to retrain the links when it is time to exit the sleep state and enter the active state L0.

In some embodiments, a system administrator observes the state of the network (e.g., the workloads being processed by the GPUs) and selects the number of links to be transitioned to the sleep state, and then observes over time how the system is performing. The system administrator may then dynamically adjust the number of links in the sleep state, either transitioning more of the links to the sleep state or transitioning links from the sleep state to active state L0 (or to the power saving state L1), according to the observed changes in the system performance and power. In some embodiments, an optimization method may be automatically applied which observes the system performance and power and/or changes in system performance and power, and dynamically adjusts the number of links in the sleep state.

In addition to determining the number of links to transition to the sleep state, the location of the links in the network to be put into the sleep state may also need to be considered in order to maximize both system performance and power savings. If the locations of the links in the network to be put into the sleep state are not considered, some of the remaining links may become bottlenecks and lead to network degradation which may in turn lead to performance degradation of the workloads. Therefore, in some embodiments, the sleep state is distributed over the interconnects so that a given number or fraction of the links of each interconnect are transitioned into the sleep state. In other embodiments, more complex algorithms may be applied which consider local traffic conditions, and allocate the sleep state to links over interconnects conveying, or predicted to convey, less traffic.

Embodiments of the disclosure may be used to manage links between any suitable nodes. The nodes may include processing nodes (e.g., CPUs and/or GPUs) and optionally one or more switches. The processing nodes may be directly connected via the links and/or indirectly connected via switches. The switches may be optionally directly connected to each other via one or more links. The nodes may be connected via interconnects including multiple links so that one or more links of the interconnects may be transitioned in and out of the sleep state as desired.

The sleep state transitions may be managed via a central entity such as a resource manager and/or by local entities such as resource managers operating in each node. Some embodiments may include various levels of entities which manage the power states of the devices.

### SYSTEM DESCRIPTION

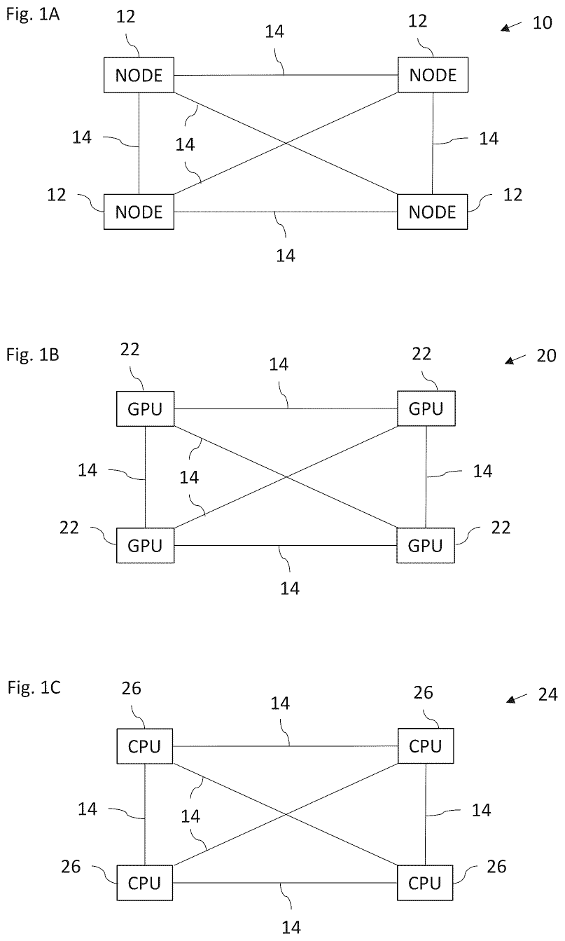

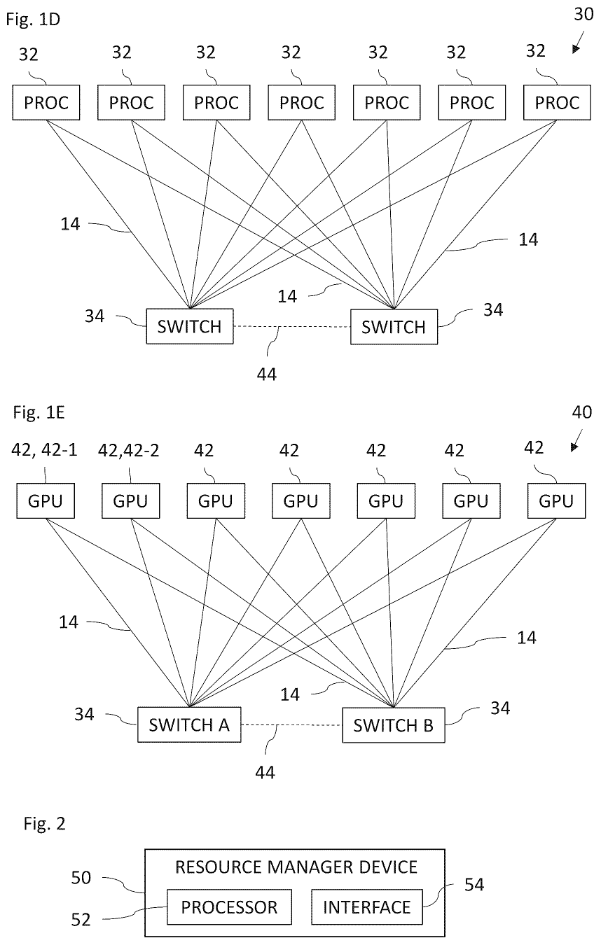

Reference is now made to FIGS. 1A-E, which are block diagram views of computer systems constructed and operative in accordance with an embodiment of the present disclosure. The systems of FIGS. 1A-E are distributed computing systems, comprising multiple nodes interconnected by multiple physical links to convey traffic between the nodes.

FIG. 1A shows a computer system 10 including multiple nodes 12 interconnected via interconnects 14 between each pair of nodes 12. Each interconnect 14 may include multiple physical links configured to convey traffic between the nodes 12. FIGS. 1B-1E show examples of different types of nodes 12 and different topologies.

FIG. 1B shows a computer system 20 including multiple GPUs 22 interconnected via interconnects 14 between each pair of GPUs 22. FIG. 1C shows a computer system 24 including multiple CPUs 26 interconnected via interconnects 14 between each pair of CPUs 26. In the examples of FIG. 1A-C each node is connected directly to each other node via one or more physical links.

FIG. 1D shows a computer system 30, which includes nodes including processing devices 32 and switches 34. The processing devices 32 are connected indirectly via switches 34 using interconnects 14 (only some labeled for the sake of simplicity) comprising one or more physical links. Each processing device 32 is connected to each switch 34 via at least one interconnect 14. The processing devices 32 may include CPUs and/or GPUs. FIG. 1E shows a computer system 40, which is substantially the same as computer system 30 except that the processing devices 32 are all GPUs 42. In the examples of FIGS. 1D and 1E, the switches 34 may optionally be connected directly to each other via one or more of physical links 44 or an interconnect.

The above computer systems are examples of topologies which may be managed according to different states such as active state L0, power saving state L1, and sleep state. Any suitable topology including any suitable connection of nodes may be managed according to the different states described herein.

Reference is now made to FIG. 2, which is a resource manager device 50 for use in the computer systems of FIGS. 1A-E. The resource manager device 50 may include a processor 52 and an interface 54 to connect with the other nodes in the system. The processor 52 is configured to control transition among states of physical links (e.g., grouped by interconnects 14) interconnecting the nodes 12 (e.g., GPUs 22, 42 CPUs 26, processing devices 32, and/or switches 34).

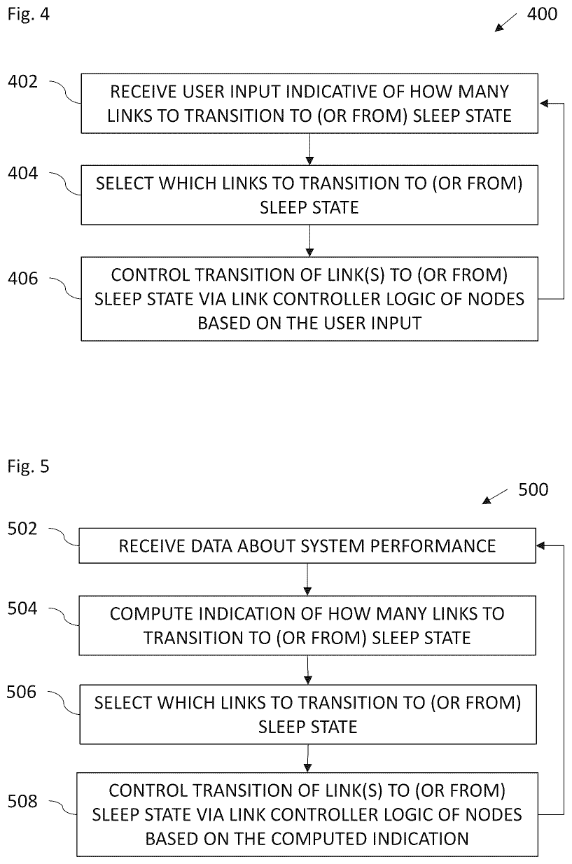

The resource manager device 50 may be a stand-alone device which is independent of the nodes which it is managing, or it may be implemented in one or more of the nodes that it is managing, e.g., using distributed computing to provide the functionality of the resource manager device 50 among many nodes 12 and/or other devices. The functionality of resource manager device 50 is described in more detail with reference to FIGS. 4 and 5.

In practice, some or all of the functions of processor 52 may be combined in a single physical component or, alternatively, implemented using multiple physical components. These physical components may comprise hard-wired or programmable devices, or a combination of the two. In some embodiments, at least some of the functions of the processor 52 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

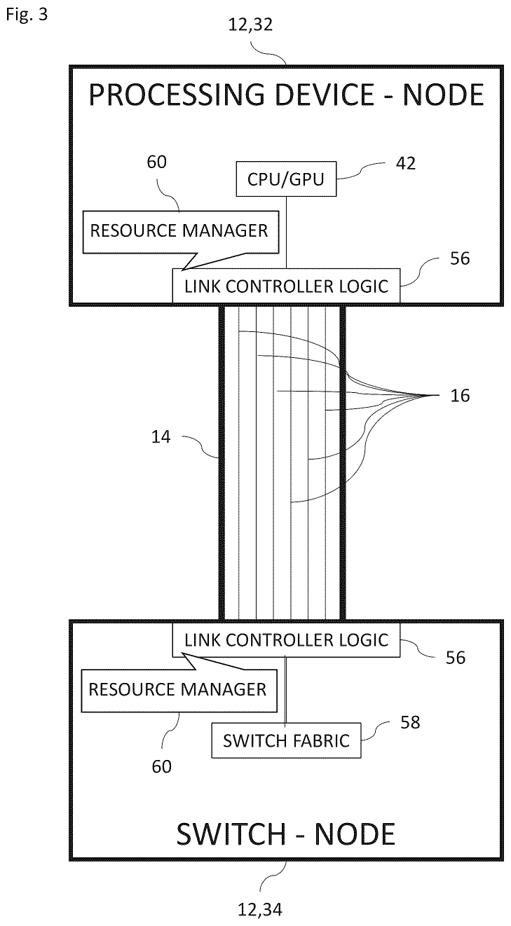

Reference is now made to FIG. 3, which is a block diagram view of example nodes 12 constructed and operative in accordance with an embodiment of the present disclosure. FIG. 3 shows that one of the nodes 12 is one of the processing devices 32, and that one of the nodes 12 is one of the switches 34. The processing device 32 and the switch 34 are connected via interconnect 14 which includes a plurality of physical links 16. The interconnect 14 may include any suitable number of links, e.g., one or more links, such as eighteen links.

The processing device 32 may include a CPU or GPU 42 and link controller logic 56. The switch 34 may include switch fabric 58 and link controller logic 56. The link controller logic 56 of each device 32, 34 controls the interconnect 14 between the two devices, as described in more detail below. The switch fabric 58 controls forwarding of data/packets received by the switch 34 to other nodes in the system by other interconnects 14.

The link controller logic 56 may include a resource manager 60, described in more detail below. The resource manager 60 is a local resource manager managing sleep state transitions of the physical links 16 of the interconnect(s) 14 connected to the device in which the resource manager 60 resides whereas resource manager device 50 of FIG. 2 is a global resource manager managing resources and sleep state transitions for many interconnects 14 associated with different nodes 12.

The link controller logic 56 of each node 12 is configured to control transitions of the physical links 16 of interconnects 14 connected to that node 12. For any physical link 16 that is connected to that node 12, the link controller logic 56 of that node 12 is configured to control transitions of the physical link 16 among states including: active state L0; power saving state L1; and sleep state.

The active state L0 is a state in which the traffic is allowed to be conveyed by the physical link 16 and even when the active state L0 is not conveying traffic it uses more power than the power saving state L1 and the sleep state. In active state L0, the physical link 16 may convey traffic, or remain idle for short periods, according to the traffic assigned to the physical link 16.

The power saving state L1 is a state in which traffic is not allowed to be conveyed by the physical link 16. The exit latency of the power saving state L1 to active state L0 may have any suitable value, for example in the range of 10 to 150 microseconds.

The sleep state is a state in which traffic is not allowed to be conveyed by the physical link 16 and provides higher power saving than the power saving state L1 per unit time. The exit latency of the sleep state to active state L0 is greater than the exit latency of the power saving state L1 to the active state L0. The exit latency of the sleep state to active state L0 may have any suitable value, for example in the range of 1 to 10 seconds. In other embodiments, the ranges of the exit latency from the power saving state L1 and the sleep state to the active state L0 may be different, but generally the exit latency from the sleep state to the active state L0 is higher than the exit latency from power saving state L1 to the active state L0.

In some embodiments, the link controller logic 56 is configured to automatically change the state of the physical link 16 from the active state L0 to the power saving state L1 in response to the physical link 16 being idle of traffic for a given time period, and to automatically change the state of the physical link 16 from the power saving state L1 to the active state L0 in response to the physical link 16 being assigned traffic to convey.

The link controller logic 56 is configured to perform periodic link recalibration to maintain electrical quality of the physical link 16 while the physical link 16 is in power saving state L1, and not perform periodic link recalibration of the physical link 16 while in the physical link 16 is in the sleep state. The periodic link recalibration leads to the lower exit latency and higher power usage of the power saving state L1 compared to the sleep state.

Each of the links may be independently set to a given state selected from the active state L0, power saving state L1, and sleep state, or any other suitable state. For example, if one of the interconnects 14 includes eighteen physical links 16, eight of the physical links 16 may be set to sleep state, while eight of the physical links 16 may be allowed to toggle between active state L0 and power saving state L1 according to the traffic being conveyed by the physical links 16.

In some embodiments, hardware of the link controller logic 56 may control the transitions between active state L0 and power saving state L1 for any one of the physical links 16, while transitions to and from the sleep state for any one of the physical links 16 may be controlled by software, firmware, or hardware of the link controller logic 56. In some embodiments, some or all of the functions of link controller logic 56 may be combined in a single physical component or, alternatively, implemented using multiple physical components. These physical components may comprise hard-wired or programmable devices, or a combination of the two. In some embodiments, at least some of the functions of the link controller logic 56 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 4, which is a flowchart 400 including steps in a method of operation of the resource manager device 50 of FIG. 2. In some embodiments, a system administrator observes the state of the network (e.g., the workloads being processed by the GPUs) and selects the number of links to be transitioned to the sleep state (or alternatively select the number of links to remain active), and then observes over time how the system is performing (e.g., how the workload performance changes (e.g., improves or worsens) according to the link width (e.g., the number of active links versus links in the sleep state)) and the power of the system (e.g., how much power the system consumes). The system administrator may then dynamically adjust the number of links in the sleep state, either transitioning more of the links to the sleep state or transitioning links from the sleep state to active state L0 (or power saving state L1), according to the observed changes in the system performance and power.

In some embodiments, the user or system administrator may request the number of physical links 16 to remain active or the number of physical links 16 that should be in sleep state or the number of physical links 16 to transition to, or from, the sleep state. Therefore, in some embodiments, the interface 54 of the resource manager device 50 is configured to receive user input indicative of how many physical links 16 in the system to transition into the sleep state from the power saving state L1 and/or active state L0 (or vice-versa) (block 402). The user may provide the total number of physical links 16 to be in sleep state (or remain active), or the total number of physical links 16 to be transitioned to the sleep state or removed from the sleep state. Instead of providing the total number of physical links 16, the user may provide a percentage of physical links 16, or fraction of physical links 16, or the bandwidth of the physical links 16 that should be in, transitioned to, or removed from, the sleep state, or remain active.

The user generally provides the number of physical links 16 that should remain active or transition to the sleep state etc. However, the selection of the actual physical links 16 (i.e., which physical links 16) to remain active and/or transition to sleep state may be performed by processor 52 of the resource manager device 50 with optional assistance from the resource manager 60 of the nodes 12 and optionally with assistance from other system entities. The processor 52 aims to ensure that traffic is properly balanced in the system and between the nodes 12 (e.g., GPUs 42, CPUs 26, processing devices 32, switches 34) to provide optimum performance and proper network connectivity to minimize or eliminate dropped packets or sub-optimal network performance.

As an example of connectivity issues, GPU 42-1 and GPU 42-2 of FIG. 1E are connected using interconnects 14 via switch A and switch B. If all the physical links 16 from GPU 42-1 to switch A are transitioned to sleep state and all the physical links 16 from GPU 42-2 to switch B are transitioned to sleep state, the fabric has no connectivity between GPU 42-1 and GPU 42-2. To avoid such problems, the processor 52 may be configured to coordinate among the nodes 12 which physical links 16 to keep active and which physical links 16 to transition to the sleep state. For example, if it is determined that X links should be transitioned to sleep state for GPU 42-1 and GPU 42-2, X/2 links connected to switch A and X/2 links connected to switch B may be transitioned to the sleep state and the remaining links remain active.

The processor 52 is configured to select which physical links 16 to transition to, or from, the sleep state (block 404) and control transition of the states of the selected physical links 16 (optionally of each interconnect 14) from the power saving state L1 and/or the active state L0 to the sleep state (or from the sleep state to the active state L0 or to the power saving state L1) based on the received user input and the selected physical links 16 (block 406). In some embodiments, prior to changing the sleep status of the physical links 16, if the system is processing workloads, the workload processing needs to be paused. In other embodiments, the sleep status of the physical links 16 may be changed while the processing devices 32 (e.g., GPUs 22, 42 or CPUs 26) are processing workloads.

Reference is now made to FIG. 5, which is a flowchart 500 including steps in an alternative method of operation of the resource manager device 50 of FIG. 2. In some embodiments, an optimization method may be automatically applied which observes the system performance and/or power, and/or changes in system performance and/or power, and dynamically adjusts the number of links in the sleep state.

The interface 54 of resource manager device 50 is configured to receive data indicative of system performance and/or power (block 502). System performance data may include any one or more of the following: link utilization patterns; amount of packet transfers; amount/percentage of idle time, compute performance; communication overlap versus exposed communications (i.e., portions that are not overlapped, meaning that the system needs to wait for this communication to finish before it can perform the next batch of compute); and/or application performance. The processor 52 is configured to compute an indication of how many of the physical links are to transition into, or from, the sleep state based on system performance and/or power (block 504). The indication may include the total number of physical links 16 to be in the sleep state (or remain active), or the total number of physical links 16 to be transitioned to sleep state or removed from sleep state. Instead of providing the total number of physical links 16, the processor 52 may provide a percentage of physical links 16, or fraction of physical links 16, or the bandwidth of the physical links 16 that should be in, transitioned to, or removed from, the sleep state, or remain active. The processor 52 is configured to select which physical links 16 to transition to, or from, the sleep state (block 506), and control transition of the states of the selected physical links 16 (optionally of each interconnect 14) from the power saving state L1 and/or active state L0 to the sleep state (or from the sleep state to the active state L0 or the power saving state L1) based on the computed indication (block 508).

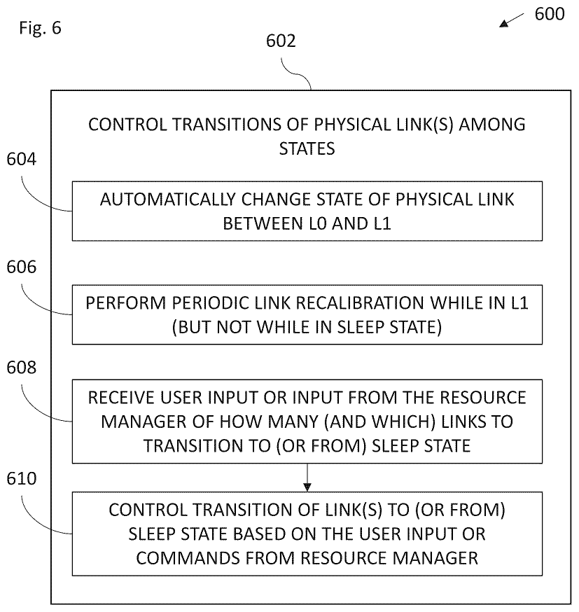

Reference is now made to FIG. 6, which is a flowchart 600 including steps in a method of operation of link controller logic 56 for use in the computer systems of FIGS. 1A-E. The link controller logic 56 is configured to control transitions of physical links 16 among different states including the active state L0, the power saving state L1, and the sleep state (block 602).

In some embodiments, the link controller logic 56 is configured to automatically change the state of any physical link 16 (which is not in the sleep state) from the active state L0 to the power saving state L1 in response to the physical link 16 being idle of the traffic for a given time period, and to automatically change the state of the physical link 16 from the power saving state L1 to the active state L0 in response to the physical link 16 being assigned traffic to convey (block 604).

The link controller logic 56 is configured to perform periodic link recalibration to maintain electrical quality of the physical link 16 while the physical link 16 is in power saving state L1, and not perform periodic link recalibration of the physical link 16 while in the physical link 16 is in the sleep state (block 606). The periodic link recalibration leads to the lower exit latency and higher power usage of the power saving state L1 compared to the sleep state.

A user or system administrator may provide user input regarding the number of physical links 16 to transition to, or from, the sleep state. In some embodiments, the user input may be provided directly to the relevant node(s) 12. In some embodiments, the user input may be provided to the resource manager device 50 which either provides the user input to the relevant node(s) 12 or provides commands to the node(s) 12 to transition one or more given physical links 16 to, or from, the sleep state. In some embodiments, the resource manager device 50 computes the number of physical links 16 to transition to, or from, the sleep state, based on system performance and/or power, as described above, and provides the computed number of physical links 16 to transition to, or from, the sleep state, to the relevant node(s) 12, which select which physical links 16 to transition to the sleep state and which links should remain active.

Therefore, the link controller logic 56 of a given node is configured to receive user input (or input from the resource manager device 50) indicative of how many of the multiple physical links to transition into the sleep state (block 608). The link controller logic 56 is configured to control transition of one or more physical links 16 of one or more interconnects 14 (connected to the link controller logic 56) into, or from, the sleep state based on the user input (or input from the resource manager device 50) (block 610).

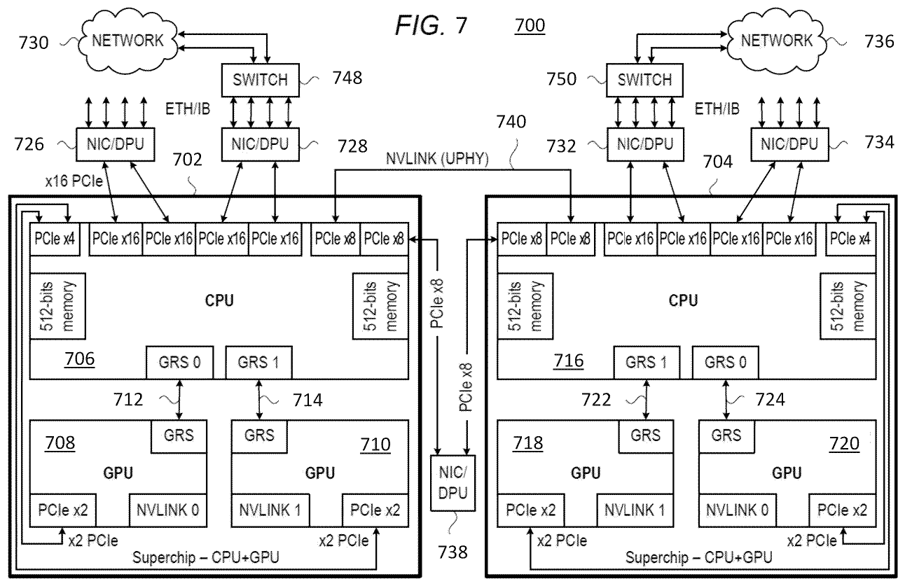

Reference is now made to FIG. 7, which is a block diagram that schematically illustrates a computing system 700, e.g., a data center or a High-Performance Computing (HPC) cluster, in accordance with an embodiment of the present disclosure.

System 700 comprises a plurality of subsystems, e.g., multiple processing devices coupled to each other, multiple network devices, and multiple networks, according to at least one embodiment. Computing system 700 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 700 and to one or more external networks 730, 736. In the present example, system 700 comprises a packet switch 748 that connects NIC/DPU 728 to network 730, and a packet switch 750 that connects NIC/DPU 732 to network 736.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 700 can include one or more CPUs and one or more GPUs.

FIG. 7 also demonstrates an example architecture of a multi-GPU architecture. As illustrated in the figure, computing system 700 includes a processing device 702 with a multi-GPU architecture. In particular, processing device 702 may be a system-on-chip and includes multiple subsystems such as a CPU 706, a GPU 708, and a GPU 710. CPU 706 can be coupled to GPU 708 via a die-to-die (D2D) or chip-to-chip (C2C) interconnect 712, such as a Ground-Referenced Signaling interconnect (GRS interconnect). CPU 706 can be coupled to GPU 710 via a D2D or C2C interconnect 714. CPU 706 can also couple to GPU 708 and GPU 710 via PCIe interconnects.

CPU 706 can be coupled to one or more NICs or DPUs, which are coupled to one or more networks. For example, as illustrated in FIG. 7, CPU 706 is coupled to a first NIC/DPU 726, which is coupled to a network 730. CPU 706 is also coupled to a second NIC/DPU 728, which is coupled to network 730 via switch 748. NIC/DPU 726 and NIC/DPU 728 can be coupled to network 730 over Ethernet (ETH), NVLINK or InfiniBand (IB) connections, for example.

Computing system 700 also includes a processing device 704 with a multi-GPU architecture. In particular, processing device 704 includes multiple subsystems including a CPU 716, a GPU 718, and a GPU 720. CPU 716 can be coupled to GPU 718 via a D2D or C2C interconnect 722. CPU 716 can be coupled to GPU 720 via a D2D or C2C interconnect 724. CPU 716 can also couple to GPU 718 and GPU 720 via PCIe interconnects. CPU 716 can be coupled to one or more NICs or DPUs, which are coupled to one or more networks. For example, as illustrated in FIG. 7, CPU 716 is coupled to a first NIC/DPU 732, which is coupled to a network 736. CPU 716 is also coupled to a second NIC/DPU 734, which is coupled to network 736 via switch 750. NIC/DPU 732 and NIC/DPU 734 can be coupled to network 736 over Ethernet (ETH), NVLINK or InfiniBand (IB) connections.

In at least one embodiment, processing device 702 and processing device 704 can communicate with each other via a NIC/DPU 738, such as over PCIe interconnects. Processing device 702 and processing device 704 can also communicate with each other over a high-bandwidth communication interconnect 740, such as an NVLink interconnect or other high-speed interconnects. The packet switches in FIG. 7 may comprise, for example, Nvidia Quantum-2 switches. The NICs/DPUs in the figure may comprise, for example, Nvidia Bluefield DPUs.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A distributed computing system, comprising multiple nodes to be
interconnected by multiple physical links to convey traffic between the nodes, each node comprising link controller logic to control transitions of a physical link of the multiple physical links among states including:
an active state L0 in which the traffic is allowed to be conveyed by the physical link;
a power saving state L1 in which traffic is not allowed to be conveyed by the physical link and having a first exit latency to the active state L0; and
a sleep state in which traffic is not allowed to be conveyed by the physical link and providing higher power saving than the power saving state L1 and having a second exit latency to the active state L0, the second exit latency being greater than the first exit latency.

2. The system according to claim 1, wherein the link controller logic is to automatically change the state of the physical link from the active state L0 to the power saving state L1 in response to the physical link being idle of the traffic for a given time period.

3. The system according to claim 1, wherein the second exit latency of the sleep state is in the range of 1 to 10 seconds.

4. The system according to claim 3, wherein the first exit latency of the power saving state L1 is in the range of 10 to 150 microseconds.

5. The system according to claim 1, wherein the link controller logic is to:
perform periodic link recalibration to maintain electrical quality of the physical link while the physical link is in the power saving state L1; and
not perform periodic link recalibration of the physical link while in the physical link is in the sleep state.

6. The system according to claim 1, further comprising at least one resource manager is to:
receive user input indicative of how many of the multiple physical links to transition into the sleep state, wherein the physical links are grouped by interconnects between the multiple nodes; and
control transition at least one of the multiple links of at least one of the interconnects into the sleep state based on the user input.

7. The system according to claim 1, further comprising at least one resource manager is to:
compute an indication of how many of the physical links are to transition into the sleep state based on system performance and/or power; and
control transition at least one of the physical links into the sleep state based on the computed indication.

8. The system according to claim 1, wherein the nodes include processing devices and switches.

9. The system according to claim 8, wherein the processing devices include any one or more of the following: central processing units (CPUs); or graphics processing units (GPUs).

10. The system according to claim 8, wherein the processing devices are connected indirectly via the switches using the physical links, wherein each of the processing devices is connected to each of the switches via at least one respective one of the physical links.

11. The system according to claim 10, wherein the switches are connected directly to each other via at least one of the physical links.

12. The system according to claim 1, wherein the nodes are connected directly to each other via at least one of the physical links.

13. A resource manager system, comprising:
a processor to control transition among states of multiple physical links interconnecting multiple nodes, the multiple physical links being to convey traffic between the nodes; and
an interface to receive data indicative of how many physical links to transition into a sleep state from a power saving state L1 and/or an active state L0, wherein:
the processor is to control transition of the states of corresponding ones of the physical links from the power saving state L1 and/or the active state L0 to the sleep state based on the received data;
traffic is not allowed to be conveyed on the corresponding physical links in the power saving state L1, which has a first exit latency to the active state L0; and
traffic is not allowed to be conveyed on the corresponding physical links in the sleep state, which provides a higher power saving than the power saving state L1 and has a second exit latency to the active state L0, the second exit latency being greater than the first exit latency.

14. The system according to claim 13, wherein:
the interface is to receive user input indicative of how many physical links to transition into the sleep state from the power saving state L1 and/or from the active state L0; and
the processor is to control transition of the states of corresponding ones of the physical links from the power saving state L1 and/or active state L0 to the sleep state based on the received user input.

15. The system according to claim 13, wherein:
the interface is to receive data indicative of system performance and/or power;
the processor is to compute an indication of how many of the physical links are to transition into the sleep state based on system performance and/or power; and
the processor is to control transition of the states of corresponding ones of the physical links from the power saving state L1 and/or active state L0 to the sleep state based on the computed indication.

16. A distributed computing method, comprising:
conveying traffic over multiple physical links interconnecting multiple nodes;
controlling transitions of a physical link of the multiple physical links among states including:
an active state L0 in which the traffic is allowed to be conveyed by the physical link;
a power saving state L1 in which traffic is not allowed to be conveyed by the physical link and having a first exit latency to the active state L0; and
a sleep state in which traffic is not allowed to be conveyed by the physical link and providing higher power saving than the power saving state L1 and having a second exit latency to the active state L0, the second exit latency being greater than the first exit latency.

17. The method according to claim 16, further comprising automatically changing the state of the physical link from the active state L0 to the power saving state L1 in response to the physical link being idle of the traffic for a given time period.

18. The method according to claim 16, wherein the second exit latency of the sleep state is in the range of 1 to 10 seconds.

19. The method according to claim 18, wherein the first exit latency of the power saving state L1 is in the range of 10 to 150 microseconds.

20. The method according to claim 16, further comprising:
performing periodic link recalibration to maintain electrical quality of the physical link while the physical link is in the power saving state L1; and
not performing periodic link recalibration of the physical link while the physical link is in the sleep state.

21. The method according to claim 16, further comprising:
receiving user input indicative of how many of the multiple physical links to transition into the sleep state, wherein the physical links are grouped by interconnects between the multiple nodes; and
controlling transition at least one of the multiple links of at least one of the interconnects into the sleep state based on the user input.

22. The method according to claim 16, further comprising:
computing an indication of how many of the physical links are to transition into the sleep state based on system performance and/or power; and
controlling transition at least one of the physical links into the sleep state based on the computed indication.
